(19) United States
(12) Patent Application Publication
(10) Pub. No.: US 2009/0180664 A1
(43) Pub. Date: Jul. 16, 2009

(54) Master Key Identification System

(76) Inventors: Christine Efstathiades, Norwalk, CT (US); Harry Efstathiades, Norwalk, CT (US)

Correspondence Address: WIGGIN AND DANA LLP;ATTENTION: PATENT DOCKETING, ONE CENTURY TOWER, P.O. BOX 1832, NEW HAVEN, CT, 06508-1832, US

(21) Appl. No.: 12/014,856

(22) Filed: Jan. 16, 2008

(51) Int. Cl. G06K 9/00

(52) U.S. Cl. 382/100

(57) ABSTRACT

A method of identifying keys is described. The method includes scanning an unidentified master key to create an unidentified image. The unidentified image defines a first set of data having key blank and master key identifying information for the unidentified key. The first set of data is compared to a second set of data, having a plurality of identified digital images including key blank and master key identifying information of those identified digital images, to determine if the unidentified master key matches an identified master keys.

### BACKGROUND

(1) Field

The present invention generally relates to key identification. In particular, the present invention is directed to a method of scanning an unknown master key and matching it to an image of a master key in a reference library.

(2) Description of the Related Art

Generally, a standard key is made up of a head portion and a shank portion. The shank portion extends horizontally in relationship to the head portion. The general size and shape of the head portion and the shank portion are referred to as a key blank. The shank portion of a key has a specific configuration with numerous indentations and grooves which make each key unique and corresponding to a specific lock. A key with a head portion and a shank portion having grooves and indentations is referred to as a master key.

When a key is duplicated, typically the master key is matched to a corresponding key blank either manually or using an optical scanning machine. The key blank is then placed into a machine where the specific grooves and indentations are cut transforming the key blank into a duplicate master key. Known methods and systems are effective for identifying a matching key blank to be used in making a duplicate master key but not effective for identifying both a matching key blank and a matching master key.

Misplaced keys and unidentified keys are a common occurrence. In the event a key is misplaced, and located several days, months or years later, it is difficult to ascertain what lock it corresponds to. This is especially common in office buildings, apartment buildings, or any other location having a large number of active keys. Although a misplaced key which is subsequently located can be duplicated using known scanning and cutting techniques discussed above, such a process will be useless unless such key can be identified.

### BRIEF SUMMARY

One aspect of the disclosed subject matter is a method of identifying master keys. The method includes scanning an unidentified master key to create one or more unidentified digital images that define a first set of data having key blank and master key identifying information for the unidentified master key, electronically comparing the first set of data to a second set of data defined by a plurality of identified digital images of identified master keys where the second set of data having key blank and master key identifying information for each of the identified master keys, and determining whether the unidentified master key matches any one of the identified master keys.

Another aspect of the disclosed subject matter is a system for identifying keys. The system includes a scanning module, a comparison module, and a feedback module. The scanning module includes scanning an unidentified master key to create one or more unidentified digital images that define a first set of data having a key blank and master key identifying information for the unidentified master key. The comparison module includes comparing the first set of data to a second set of data defined by a plurality of identified digital images of identified master keys, the second set of data having key blank and master key identifying information for each of the identified master keys. The feedback module includes determining whether the unidentified key matches any one of the identified master keys.

Another aspect of the disclosed subject matter is a device for identifying master keys. The device includes a housing, a scanner, a memory component, and an electric circuit board. The scanner is positioned within the housing and adapted for optically scanning an unidentified master key to create a digital image of the unidentified master key. The memory component is positioned within the housing and stores information about the digital image of the unidentified master key and being in communication with the scanner. The memory component also includes information about digital images of identified master keys. The electronic circuit board is positioned within the housing. The electronic circuit board includes a means for comparing the digital image of the unidentified master key to the digital images of the identified master keys and determining whether the unidentified master key matches any of the identified master keys.

### BRIEF DESCRIPTION OF THE DRAWINGS

For the purpose of illustrating the disclosed subject matter, the drawings show a form of the disclosure that is presently preferred. However, it should be understood that the present disclosure is not limited to the precise arrangements and instrumentalities shown in the drawings, wherein:

FIG. 1 is a flow diagram of a method according to embodiments of the disclosed subject matter;

FIG. 2 is an isometric view of a device according to the disclosed subject matter;

FIG. 3 is an exploded view of the device in FIG. 2; and

FIG. 4 is a flow diagram of a system according to embodiments of the disclosed subject matter.

### DETAILED DESCRIPTION

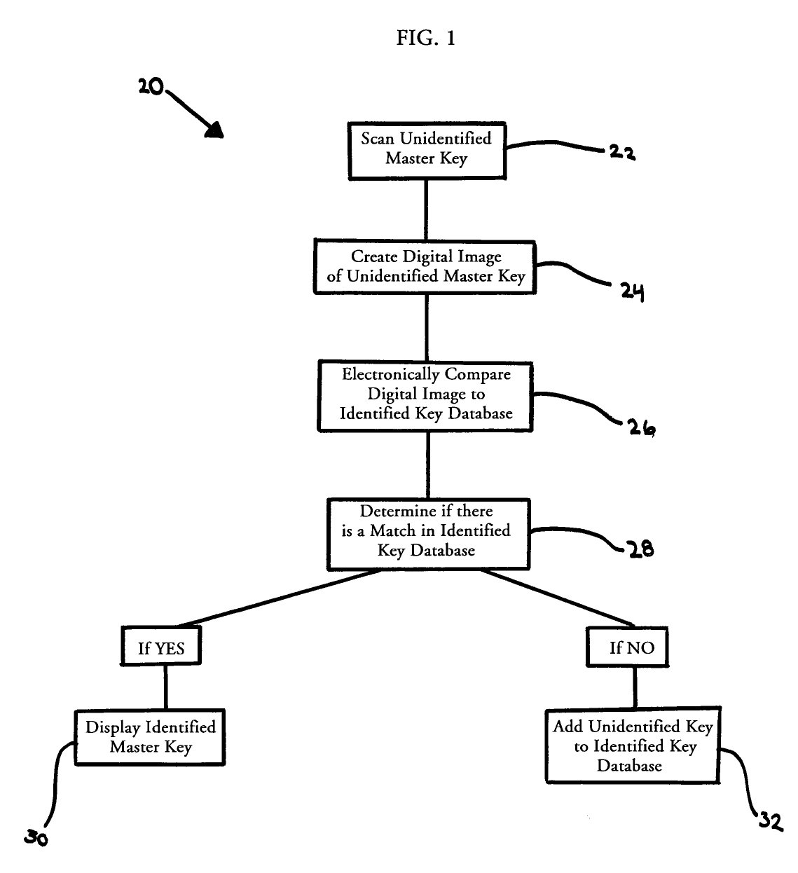

Referring now to the drawings in which like reference numerals indicate like parts, and in particular, to FIG. 1, one aspect of the disclosed subject matter is a method 20 of identifying master keys. At 22, method 20 includes scanning an unidentified master key. Typically, an unidentified digital image is formed by optically scanning the profile of the unidentified master key. By scanning the unidentified master key, one or more unidentified digital images are created at 24 that define a first set of data. The first set of data includes blank and master key identification information for the unidentified key.

At 26, the first set of data is compared to a second set of data. The second set of data includes key blank and master key information for a plurality of identified master keys. The second set of data is stored in an identified key database. At 28, it is determined whether the unidentified master key matches any one of the master keys in the identified key database. If there is a match, at 30, information relating to the identified master key is provided to a user, e.g., displayed on a screen. At 32, if no match is identified, a user can elect to add the digital image of the key along with further identifying information, e.g., a name, to the identified key database. Alternatively, the unidentified master key can be discarded.

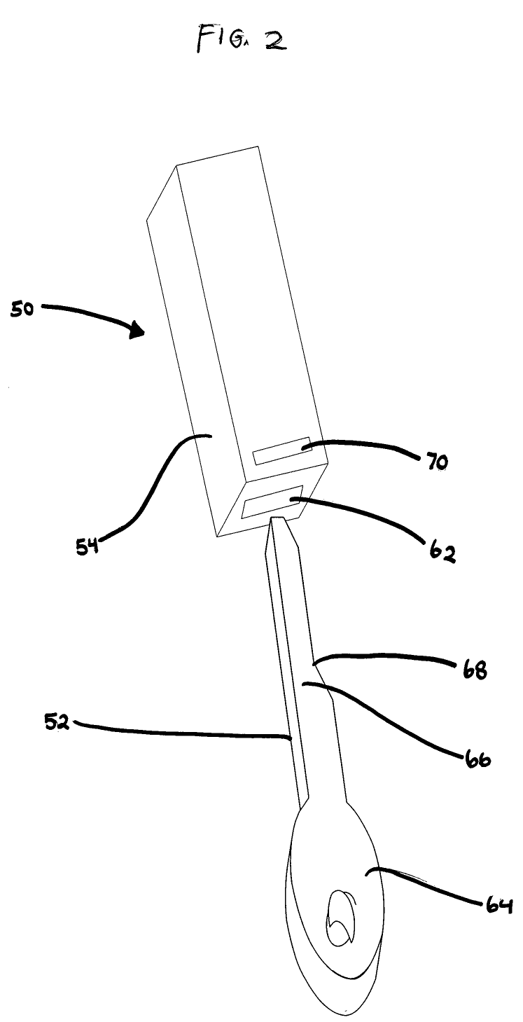

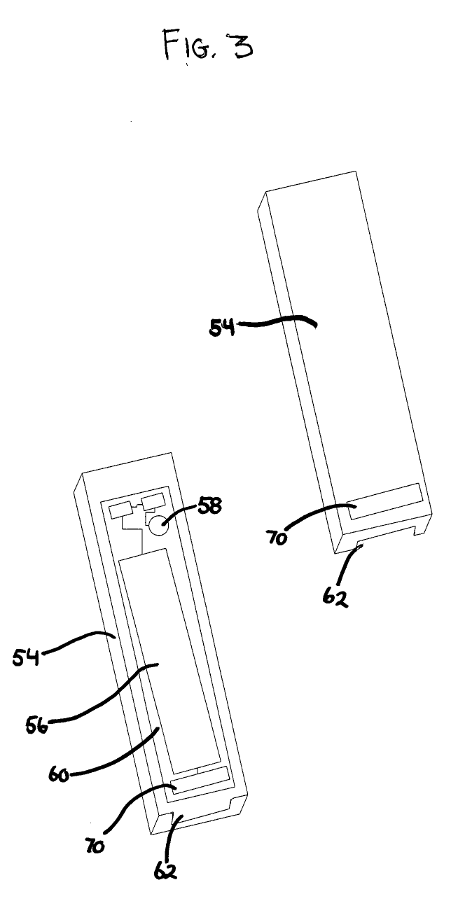

Now referring to FIGS. 2 and 3, another aspect of the disclosed subject matter includes a device 50 for identifying a master key 52. Device 50 includes a housing 54, a scanner 56, a memory component 58, an electronic circuit board 60, and a light emitting diode (LED) readout 70. Device 50 can be powered by a disposable battery, a rechargeable battery, or any other known power source. Although, device 50 typically has its own memory component 58, the device can be connected to a computer to download information to a secondary source, either for additional space or for backup purposes.

Housing 54 can be constructed of plastic, metal or any other material suitable for molding and holding the components of device 50. In one embodiment, housing 54 is the size of a handheld device having a length of about 1 inch to about 3 inches, a width of about 2 inches to about 5 inches, and a depth of about ¼ inch to about 1 inch. In an alternative embodiment, housing 54 can be adapted for installation into a computer.

Positioned within housing 54 is scanner 56. Scanner 56 can be any known scanning device adapted for optically scanning an unidentified master key to create a digital image of the unidentified master key. Examples of such scanning devices are present in the following U.S. Pat. No. 6,185,311 by Yanovsky, et al, directed to a Key Imaging System; U.S. Pat. No. 6,839,449 by Campbell, et al., directed to a Key Identification System; and U.S. Pat. No. 6,801,829 by Kawai directed to a Key Information Registration Procedure Assisting System, Recorded Medium, and Key Plate Cutter, all of which are hereby incorporated in their entirety.

Housing 54 further includes a slot 62 suitable for inserting a key. As unidentified master key 52 is inserted into slot 62, scanner 56 scans the profile of the unidentified master key. Generally, unidentified master key 52 consists of a head portion 64 and a shank portion 66. Typically, the shape of head portion 64 and the length of shank portion 66 define key blank information of unidentified master key 52. Shank 66 of unidentified master key 52 has several indentations and grooves 68 that make the unidentified master key unique. The specific size and shape of indentations and grooves 68 define the master key information that is obtained. As unidentified master key 52 is scanned, several measurements are recorded, including the size of each indentation and groove 68, the length of shank portion 66 and the size of head portion 64. This information defines a first set of data that is temporarily stored in memory component 58 of device 50.

Memory component 58 is in communication with scanner 56 via electronic circuit board 60, which is also positioned within housing 54. Memory component 58 can be random access memory, or the like effective to store information collected by scanner 56 about the unidentified master key. Memory component 58 also includes a permanent storage space that contains an identified key database to store information of identified master keys.

Memory component 58 includes a program or routine (not shown) for comparing a digital image of an unidentified master key to digital images of identified master keys. Memory component 58 allows determination of whether the unidentified master key matches any of the identified master keys. The program or routine compares digital images of the unidentified master key to determine if there is a match to any of the identified master keys in the identified key database.

LED readout 70 is positioned on one surface of housing 54. LED readout 70 is effective for displaying information about digital images. LED readout 70 can be any type of readout, e.g., a liquid crystal display (LCD) screen, a field emission display (FED), an organicLEDs (OLEDs), or the like.

In some embodiments of the disclosed subject matter, housing 54 can include a key pad, effective for allowing a user to input information into device 50. This would allow a user to enter information, such as an identifying name, to a key that is being entered into the identified key database.

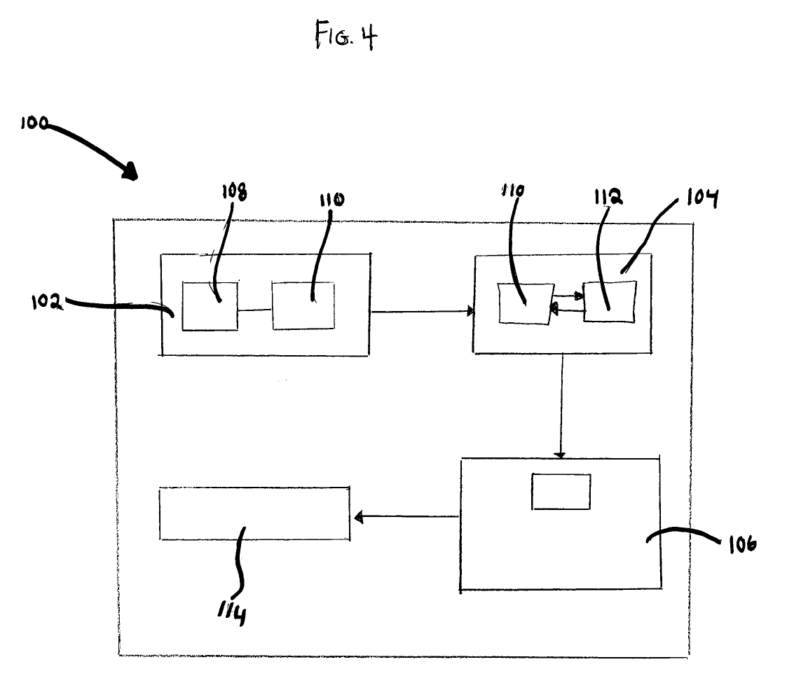

Now referring to FIG. 4, another aspect of the disclosed subject matter is a system 100 for identifying a master key. System 100 includes a scanning module 102, a comparison module 104, and a feedback module 106.

Scanning module 102 is effective for scanning an unidentified master key at 108 to create one or more unidentified digital images. The unidentified digital key images define a first set of data 110 having a key blank and master key identifying information for the unidentified master key.

First set of data 110 is then sent to comparison module 104, where it is compared to a second set of data 112. Typically, comparison module 104 contains a software program effective to store data and perform a comparison analysis of data. Such a software program can be any known software program capable of analyzing data. Second set of data 112 is defined by a plurality of identified digital images of identified master keys having key blank and master key identifying information for each of the identified master keys. Second set of data 112 is stored in comparison module 104 by means of random access memory or the like. If the unidentified digital image taken in scanning module 102 matches an identified master key in second set of data 112, then the unidentified master key is identified and the information is sent to feedback module 106. Feedback module 106 is effective for determining whether the unidentified key matches any one of the identified master keys. In some embodiments of the disclosed subject matter, feedback module 106 sends the match information to a display module 114 wherein text identifying the identified master key is displayed.

Referring now to FIGS. 1-4, in use, device 50, method 20 and system 100 can be used to identify both unidentified master keys 52 and new keys. For example, when a user obtains a new key, he or she can enter the key into the identified key database for future reference. In order to do this, the new key must be scanned. The scanning process of a new key is identical to that of unidentified master key 52 discussed above. The new key is entered into slot 62 of housing 54. A digital image is taken of the new key including specific measurements of the new key's shape, size, grooves, and indentations. The user can then add the digital image to the identified key database. The user gives the digital image an assigned name and saves the information to the identified key database.

In some embodiments of the disclosed subject matter, at the outset of the operation, the user can indicate whether he is attempting to identify an unidentified master key 52 or scanning a new key to add to the identified key database as an identified master key. In some embodiments of the disclosed subject matter, housing 54 can be equipped with a calculator or other electronic device.

The disclosed subject matter allows for an efficient, easy to use, key identifying system. Because the optical imaging creates an exact image, it is a very effective way to identify an exact match and manage multiple keys. The size of the device allows it to be easily transported.

Although the invention has been described and illustrated with respect to exemplary embodiments thereof, it should be understood by those skilled in the art that the foregoing and various other changes, omissions and additions may be made therein and thereto, without parting from the spirit and scope of the present invention. Accordingly, other embodiments are within the scope of the following claims.

What is claimed is:

1. A method of identifying master keys, said method comprising:
scanning an unidentified master key to create one or more unidentified digital images that define a first set of data having key blank and master key identifying information for said unidentified master key;
electronically comparing said first set of data to a second set of data defined by a plurality of identified digital images of identified master keys, said second set of data having key blank and master key identifying information for each of said identified master keys; and
determining whether said unidentified master key matches any one of said identified master keys.

2. A method according to claim 1, wherein said unidentified digital image is formed by optically outlining the profile of said unidentified master key to form an image.

3. A method according to claim 2, wherein said second set of data further comprises an assigned name for each of said identified master key.

4. A method according to claim 3, wherein said second set of data is stored in an identified key database.

5. A method according to claim 4, further comprising displaying said assigned name of said identified master key.

6. A method according to claim 5, further comprising assigning a name for each unidentified digital image, adding said unidentified digital image to said second set of data and storing said unidentified digital image in said identified key database.

7. A method according to claim 1, further comprising adding a new master key to said identified key database.

8. A system for identifying keys, said system comprising:
a scanning module for scanning an unidentified master key to create one or more unidentified digital images that define a first set of data having a key blank and master key identifying information for said unidentified master key;
a comparison module for comparing said first set of data to a second set of data defined by a plurality of identified digital images of identified master keys, said second set of data having key blank and master key identifying information for each of said identified master keys; and
a feedback module for determining whether said unidentified key matches any one of said identified master keys.

9. A system according to claim 8, wherein said scanning module comprises a means for optically scanning a master key.

10. A system according to claim 9, wherein said comparison module comprises a memory component.

11. A system according to claim 10, wherein said memory component comprises a means for loading a program effective to carry out functions of said system.

12. A system according to claim 11, wherein said comparison module comprises a means for identifying a match of said unidentified master to key to any one of said identified keys.

13. A system according to claim 12, further comprising a display module wherein text identifying said identified master key is displayed.

14. A system according to claim 13 wherein said storage space is random access memory storage.

15. A device for identifying master keys, said device comprising:
a housing;
a scanner positioned within said housing, said scanner being adapted for optically scanning an unidentified master key to create a digital image of said unidentified master key;
a memory component positioned within said housing for storing information about said digital image of said unidentified master key, said memory component being in communication with said scanner and said memory component also including information about digital images of identified master keys; and
an electronic circuit board within said housing, wherein said electronic circuit board includes means for comparing said digital image of said unidentified master key to said digital images of said identified master keys and determining whether said unidentified master key matches any of said identified master keys.

16. A device according to claim 15, wherein said housing further comprises an alphanumeric keypad.

17. A device according to claim 16, wherein said housing further comprises a slot effective for inserting a key.

18. A device according to claim 17, wherein said memory component further comprises an identified key database.

19. A device according to claim 15, further comprising a readout for displaying information about said digital images.
